(19) United States
(12) Patent Application Publication
(10) Pub. No.: US 2019/0076932 A1
(43) Pub. Date: Mar. 14, 2019

(54) APPARATUS AND METHOD FOR MINIMIZING ELONGATION IN DRILLED HOLES

(71) Applicant: SPIRIT AEROSYSTEMS, INC., Wichita, KS (US)

(72) Inventors: Amitab Vyas, Wichita, KS (US); John R. Dye, Wichita, KS (US); Gregorio Balandran, Wichita, KS (US)

(73) Assignee: SPIRIT AEROSYSTEMS, INC., Wichita, KS (US)

(21) Appl. No.: 15/704,116

(22) Filed: Sep. 14, 2017

(51) Int. Cl. B23B 7/06; B23B 25/06; B23B 3/26; B23B 27/16

(52) U.S. Cl. CPC B23B 7/06; B23B 25/06; B23B 2270/486; B23B 27/16; B23B 2260/0482; B23B 3/26

(57) ABSTRACT

A drilling apparatus and method for drilling holes into a composite workpiece. The drilling apparatus may include an end effector, a drill bit, and a control system. The end effector may include an end effector housing, a drill bit attachment, a rotation actuator, and a linear motion actuator. The linear motion actuator may convert rotary motion of a rotary motor into linear motion of the drill bit attachment. The drill bit may have a widest portion which cuts a hole into the workpiece and a narrow flute portion limiting contact time between the drill bit and the workpiece. The control system may control a speed of the linear motion actuator, with a first speed as the drill bit is plunged into the workpiece and a second speed, slower than the first speed, as the drill bit is retracted out of the workpiece.

### BACKGROUND

Sandwich panels with perforated skins are typically incorporated into aircraft engine nacelles to reduce the amount of engine noise reaching the ground during flight. The perforated skins include numerous holes, typically about 1 mm in diameter, which cover between 5% and 10% of a nacelle panel's surface area. This equates to roughly 1,000,000 holes in a single panel, and each nacelle may contain multiple panels.

The holes may be molded into composite skins using pinmats, but this process is labor and flow-time intensive, requires pre-curing of the skin prior to assembly of the sandwich panel, and necessitates tooling that would not otherwise be required. The holes may also be formed by an abrasive erosion process, but this too has drawbacks. Maskant must be applied to the skin manually, and as with the pinmat process, the skin must be pre-cured prior to assembly of the sandwich panel.

Mechanical drilling using a conventional drill bit overcomes some of these limitations, as mechanically drilled holes may be formed in a finished sandwich panel, thus eliminating separate curing operations for individual skins. However, prior art drilling equipment is too slow and expensive to cost-effectively drill the large number of holes required. To meet desired production rates, many expensive machines would be required, operating in parallel. In addition to the expense, these machines would consume a large amount of factory floor space and would increase the inventory that must be maintained in-process at any given time.

Some perforating robots are much less expensive than conventional drilling machines, and are also much more compact. Unfortunately, these robots lack the precision and stability to successfully serve as platforms for conventional drilling equipment operated in conventional means.

Thus, there is a need for an improved apparatus and method for perforating skins for nacelle sandwich panels.

### SUMMARY OF THE INVENTION

Embodiments of the present invention solve the above-mentioned problems and provide a distinct advance in the art of nacelle sandwich panel fabrication. One embodiment of the invention is a drilling apparatus having an end effector, a drill bit attached to the end effector, and a control system. The drill bit may include a forward end, an aftward end opposite the forward end, a tip formed at the forward end, a widest portion aftward of the tip, and a narrow flute portion aftward of the widest portion. The flute portion may extend between the widest portion and the end effector. The flute portion may also have a smaller diameter than the widest portion. The control system may send control signals to actuators of the end effector commanding rotation of the drill bit and commanding the end effector to move the drill bit laterally outward and inward.

In another embodiment of the invention, the end effector may include an end effector housing, a drill bit attachment extending outward from the end effector housing, a rotation actuator, and a linear motion actuator. The rotation actuator may be coupled with the drill bit attachment for actuating rotation of the drill bit attachment. The linear motion actuator may actuate linear motion of the drill bit attachment toward and away from the workpiece. The drill bit may be attached to the drill bit attachment and may have a forward end, an aftward end opposite the forward end, a tip formed at the forward end, a widest portion aftward of the tip, and a narrow flute portion aftward of the widest portion. The flute portion may extend between the widest portion and the end effector, and may have a smaller diameter than the widest portion. Furthermore, the widest portion may have a smaller length than the narrow flute portion. The control system may send control signals to the end effector commanding the end effector to rotate the drill bit and commanding the end effector to move laterally outward and inward. In addition, the control system may command the end effector to move laterally outward toward the workpiece at a first speed and command the end effector to move laterally back inward away from the workpiece at a second speed. The second speed may be faster than the first speed.

In yet another embodiment of the invention, a drilling apparatus described above may be implemented in a method of drilling holes into a composite workpiece. The method may include the steps of actuating rotation of a drill bit attachment and a drill bit attached therein, then actuating the drill bit attachment linearly toward the composite workpiece at a first speed, thus forming a hole therethrough. The method may also include a step of actuating the drill bit attachment linearly away from the composite workpiece at a second speed that is greater than the first speed, thus limiting the amount of time the widest portion of the drill bit contacts workpiece while being withdrawn through the hole.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a side view of a panel perforation drilling apparatus constructed according to embodiments of the present invention;

FIG. 2 is a perspective view of the drilling apparatus of FIG. 1;

FIG. 3 is a perspective view of the housing of the drilling apparatus of FIG. 1;

FIG. 4 is a perspective view of the drilling apparatus of FIG. 1 with part of the housing removed;

FIG. 5 is an alternative embodiment of the panel perforation drilling apparatus;

FIG. 6 is a side view of oval-shaped gears configured to vary a lateral motion speed of a drill bit of FIG. 1;

FIG. 7 is a schematic view of a drill bit of the drilling apparatus of FIG. 1;

FIG. 8 is a schematic view of an alternative embodiment of the drill bit of FIG. 7;

FIG. 9 is a block diagram of the drilling apparatus of FIG. 1, including a control system communicatively coupled with actuators which are mechanically linked to the drill bit and its drill bit attachment; and

FIG. 10 is a flow chart illustrating a method of drilling holes into a workpiece in accordance with embodiments of the present invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

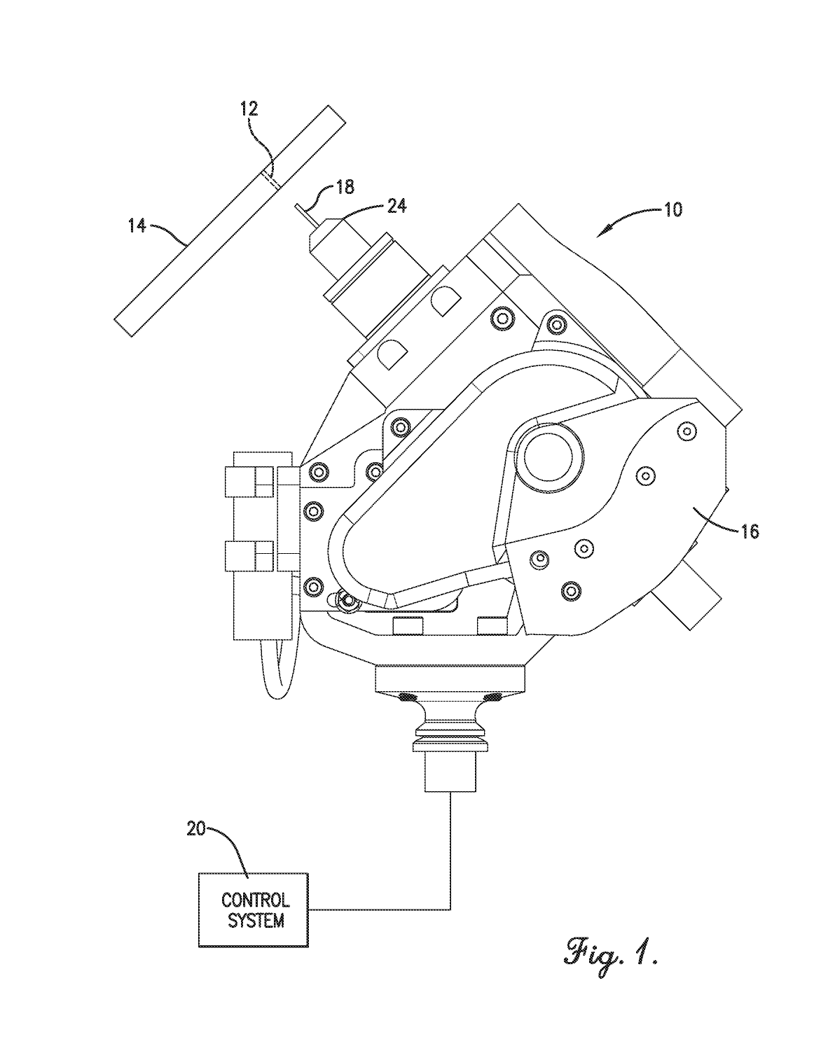

A drilling apparatus 10 constructed in accordance with embodiments of the present invention is illustrated in FIG. 1. The drilling apparatus 10 is configured for drilling holes 12 into a workpiece 14, such as composite aircraft panels and composite skin of noise-reducing sandwich panels for an aircraft nacelle. However, the workpiece 14 may be any other structure susceptible to drilling without departing from the scope of the invention. The drilling apparatus 10 may include an end effector 16, a drill bit 18 attachable to the end effector 16, and a control system 20 adapted to execute method steps of a drilling process later described herein.

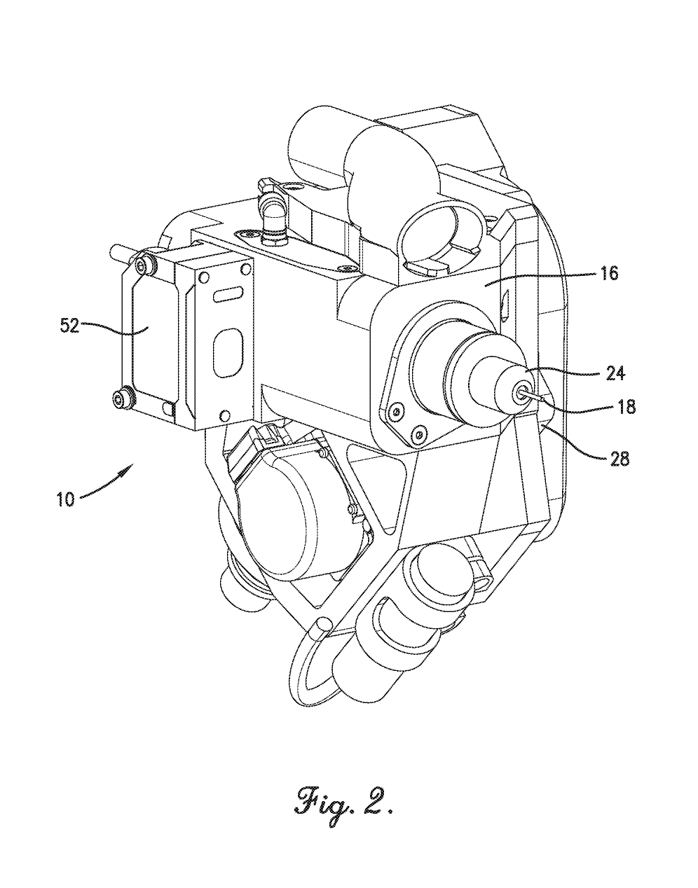

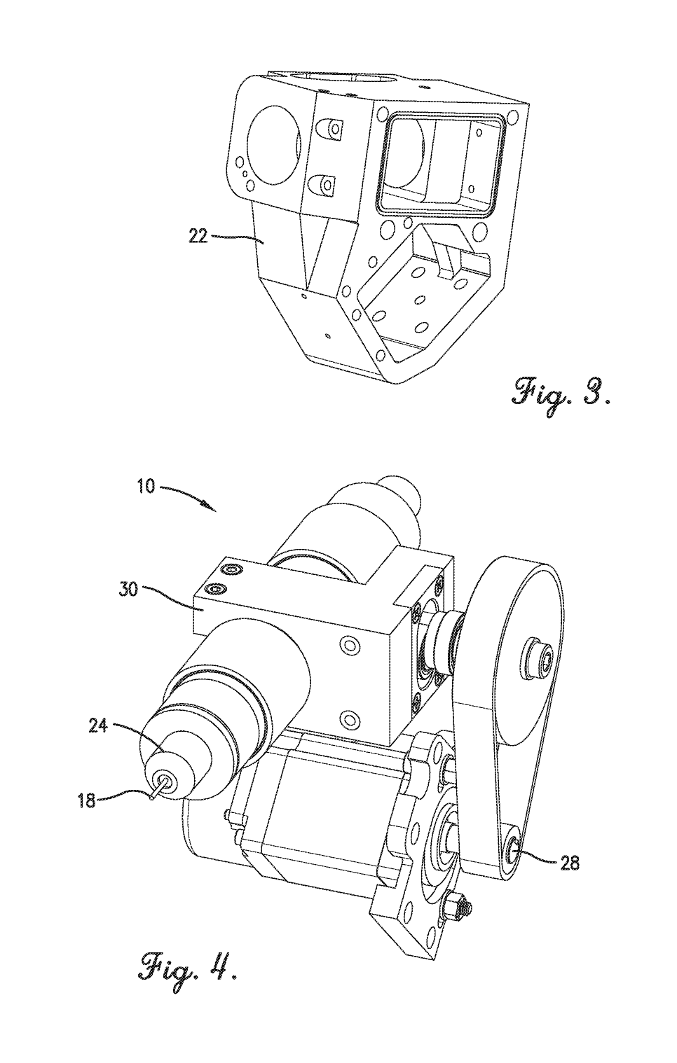

As illustrated in FIGS. 1-4, the end effector 16 may include an end effector housing 22, a drill bit attachment 24, a rotation actuator 26 configured for rotating the drill bit attachment 24 and the drill bit 18 therein, and/or a linear motion actuator 28 configured to provide linear motion toward and away from the workpiece 14. The end effector housing 22, as illustrated in FIGS. 2-4, may support various components of the drilling apparatus 10 and may have any size, shape, or configuration to structurally support those components during drilling operations. In some embodiments of the invention, the end effector housing 22 may include a monolithic unitary housing. Furthermore, as illustrated in FIG. 4, the end effector housing 22 may include and/or attach to an end effector carriage 30 supporting and stabilizing the drill bit attachment 24 and actuators 26,28 described herein.

The drill bit attachment 24 may include a quill, drill chuck, drill bit spindle, and/or any type of clamp rotatably attached to the end effector housing 22 and suitable to hold the drill bit 18 in radial symmetry therein. At least a portion of the drill bit attachment 24 may extend outward from the end effector housing 22 and may be supported thereby. At least a portion of the drill bit attachment 24 may be actuatable at any desired drilling speed via the rotation actuator 26, thereby rotating the drill bit 18. For example, the drill bit attachment 24 may spin the drill bit 18 at a rate of 50,000 to 100,000 rotations per minute, or approximately 80,000 rotations per minute. However, other rotational speeds may be used without departing from the scope of the invention.

As illustrated schematically in FIG. 9, the rotation actuator 26 may be coupled with at least a portion of the drill bit attachment 24 and configured to rotate the drill bit 18 in a clockwise and/or counterclockwise direction. The rotation actuator 26 may comprise a primary rotary motor, such as a continuously variable motor, a servo motor, or the like. However, the rotation actuator 26 may be any actuator used to automate rotation of drill bits or other rotating tools known in the art without departing from the scope of the invention.

The linear motion actuator 28 may be configured for converting rotary motion into linear motion, thus driving the drill bit 18 into the workpiece 14. Specifically, as illustrated in FIG. 9, the linear motion actuator 28 may include a secondary rotary motor 32 or actuator and a rotary-to-linear motion converter 34 mechanically linked with the secondary rotary motor 32. The rotary-to-linear motion converter 34 may be mechanically linked or otherwise attached to provide linear motion to the drill bit attachment 24. The rotary-to-linear motion converter 34 may include, for example, a crank, a cam, a rack-and-pinion, or any mechanical arrangements suitable for converting the rotary motion provided by the secondary rotary motor 32 into linear motion of the drill bit 18.

In some embodiments of the invention, the secondary rotary motor 32 is a continuously-variable motor or servo motor which may be controlled by the control system 20 to have a first speed of linear insertion into the workpiece 14 and a second speed of linear withdrawal when the drill bit 18 is pulled out, away from the workpiece 14. The second speed may be faster than the first speed. For example, servo feedback from the servo motor may be used by the control system 20 or other circuitry to govern speed thereof depending on angle readings or other position information obtained via the servo feedback. Alternatively, a stepper motor may be used to selectively switch the speed of the rotary-to-linear motion converter 34 between two or more speeds. In yet another embodiment of the invention, a cam with a predefined mechanical profile may be used to switch the speed of the rotary-to-linear motion converter 34 and thus withdrawal the drill bit 18 at a faster speed than the drill bit's insertion. In yet another embodiment of the invention, as illustrated in FIG. 6, oval or oblong-shaped gears 38 may be provided between the secondary rotary motor 32 and the rotary-to-linear motion converter 34, such that the speed of linear motion of the drill bit 18 is varied between the first speed and the second speed at set intervals.

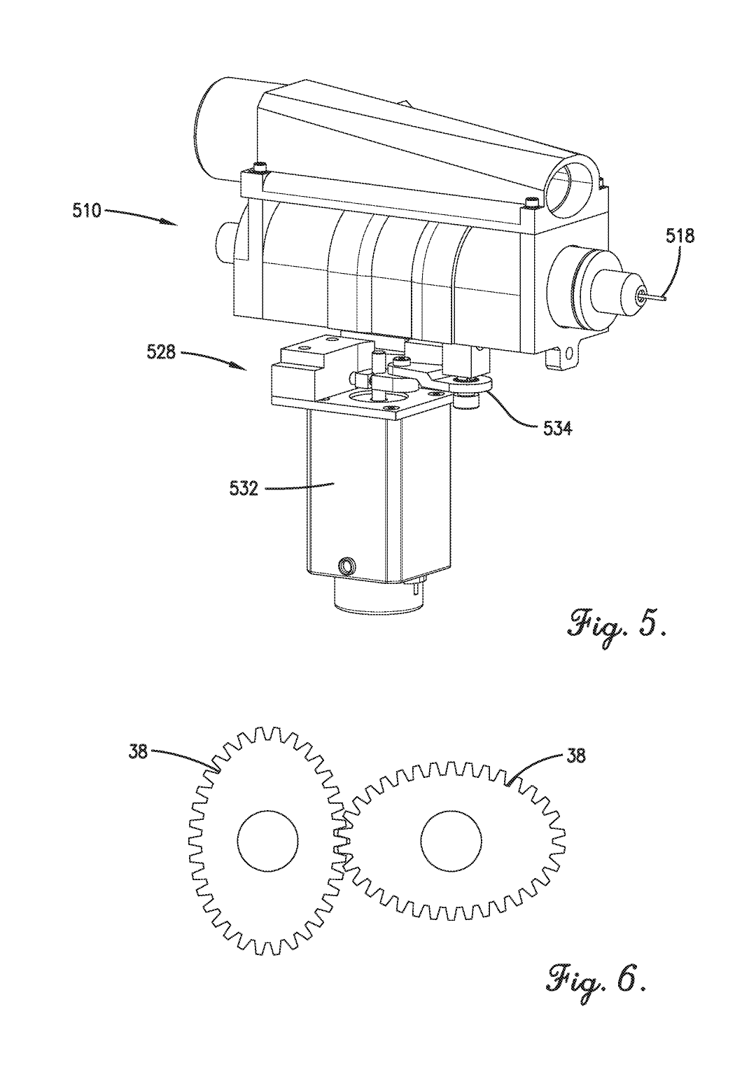

In some embodiments of the invention, the rotary-to-linear motion converter 34 may allow the secondary rotary motor 32 to continuously run in a single direction for both forward and backward motion of the drill bit attachment 24 and/or the drill bit 18 toward and away from the workpiece 14. Because the secondary rotary motor 32 does not need to reverse directions to retract the drill bit 18 from the workpiece 14, this results in quicker acceleration and eliminates any lag time present in prior art systems during withdrawal of the drill bit 18 from the hole 12 created. However, other embodiments of the invention may include a linear motion actuator 28 configured such that the secondary rotary motor 32 does reverse directions to retract the drill bit 18 from the workpiece 14. For example, as illustrated in FIG. 5, another embodiment of the invention may include an apparatus 510 substantially similar or identical to apparatus 10 in many respects, but with a crank stepper motor 532 and crank mechanism 534 operating as a linear motion actuator 528. In this embodiment of the invention, the crank stepper motor 532 would reverse directions for withdrawal of a drill bit 518 from a workpiece.

Alternatively, the secondary rotary motor 32 may be omitted and the primary rotary motor of the rotation actuator 26 may be used to both rotate the drill bit attachment 24 and/or drill bit 18 and to actuate the linear motion thereof via attachment with the rotary-to-linear motion converter 34. In particular, a speed reducing gear train or the like may be utilized between the rotation actuator 26 and the rotary-to-linear motion converter 34. Alternatively, the primary motor of the rotation actuator 26 could be omitted and the secondary rotary motor 32 may be used to rotate both the drill bit attachment 24 and/or the drill bit 18 and to actuate the linear motion thereof via attachment with the rotary-to-linear motion converter 34. Specifically, a speed-increasing gear train or the like may be utilized between the secondary rotary motor 32 and the drill bit attachment 24.

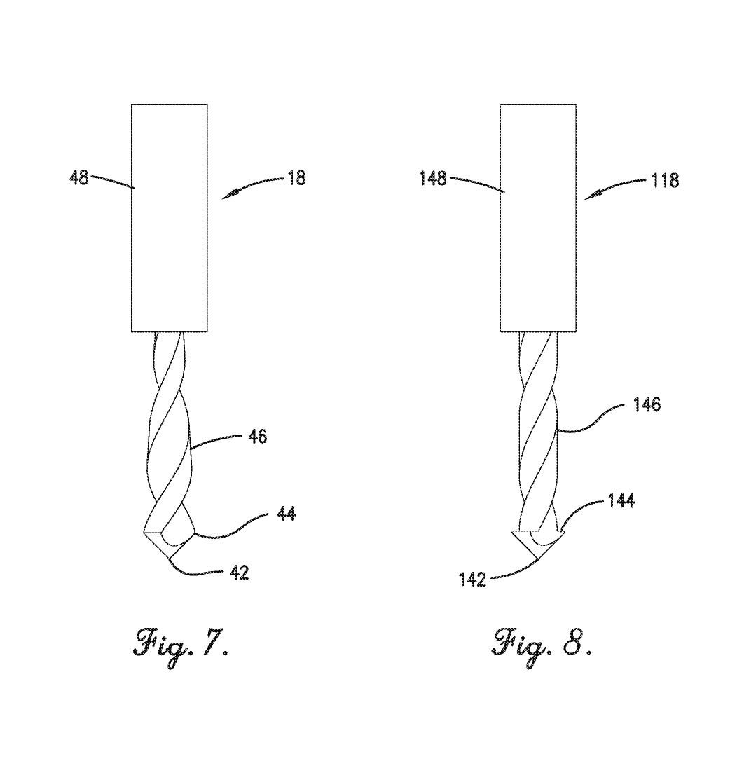

The drill bit 18, as illustrated in FIG. 7, may have a point or tip 42, a widest portion 44, and a narrow flute portion 46. In some embodiments of the invention, the drill bit 18 may also include a shank 48 for attachment within the drill bit attachment 24. For example, the shank 48 may be positioned at an aftward end of the drill bit 18 and the tip 42 may be positioned at a forward end of the drill bit 18. An angle formed from the tip 42 to the widest portion 44 may form a smaller included angle 50 than prior art drill bits. Specifically, this included angle 50 may be somewhere between 50-degrees and 110-degrees or between 80-degrees and 100-degrees. In one example embodiment of the invention, this included angle 50 may be approximately 90-degrees. Applicants have discovered that, when compared with the 120-degree included angle common in the drilling industry, this narrower included angle reduces the force required during drilling, decreasing the relative lateral or side-to-side motion between the drill bit 18 and the workpiece 14.

The widest portion 44 may have a length smaller than the flute portion 46 or may even merely be an edge at which the flute portion 46 and the included angle 50 meet. The flute portion 46 of the drill bit 18, between the shank 48 and the widest portion 44 of the drill bit 18, may have a reduced diameter as compared to a diameter of widest portion 44. For example, the flute portion 46 may taper from the widest portion 44 down to a narrower point closer to or at the shank 48 positioned in the drill bit attachment 24. However, other shapes, profiles, or configurations of the flue portion 46 having a smaller diameter than the widest portion 44 may be used without departing from the scope of the invention.

The shank 48 as illustrated in FIG. 7 may have any diameter sufficient to be secured within the drill bit attachment 24. Because only the widest portion 44 of the drill bit 18 contacts the workpiece 14 at boundaries of the holes 12 drilled thereby, and only for a short amount of time, the drilling apparatus 10 is better able to tolerate relative lateral or side-to-side motion between the drill bit 18 and the workpiece 14. Specifically, for much of the time during which the drill bit 18 is engaged with the workpiece 14, there is clearance around the drill bit 18 within the hole 12.

In one alternative embodiment of the drill bit 18, the flute portion 46 may have a substantially uniform diameter from the widest portion 44 to the shank 48, so long as the flute portion's diameter is less than the diameter of the widest portion 44. For example, as illustrated in FIG. 8, a drill bit 118 substantially similar to drill bit 18, but with an arrow-like configuration, may be used herein. The drill bit 118 may have a tip 142, a widest portion 144, a flute portion 146 having a uniform diameter that is smaller than the diameter of the widest portion, and a shank 148.

The control system 20, as illustrated in FIGS. 1 and 9, may comprise any number or combination of controllers, circuits, integrated circuits, programmable logic devices, computers, processors, microcontrollers, or other control devices and residential or external memory for storing data, status information, position information, actuator speeds, and/or other information accessed and/or generated by various components of the drilling apparatus 10. The control system may further other circuitry, sensors, connectors, and hardware known in the art. The control system 20 may be electrically and/or communicably coupled with the rotation actuator 26, the linear motion actuator 28, and/or other sensors or circuitry of the drilling apparatus 10 through wired or wireless connections to enable information to be exchanged between the various components. Wired connections may include wires or other electrical connectors, fiber optic cables, data buses, or the like. Wireless connections may include transceivers, transmitters, receivers, antenna, wireless sensors, and/or any other wireless communication devices known in the art.

The control system 20 may implement a computer program and/or code segments to perform some of the functions and method described herein. The computer program may comprise an ordered listing of executable instructions for implementing logical functions in the control system. The computer program can be embodied in any computer-readable medium for use by or in connection with an instruction execution system, apparatus, or device, and execute the instructions. In the context of this application, a “computer-readable medium” can be any means that can contain, store, communicate, propagate, or transport the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The features of the control system 20 may be implemented in a stand-alone device, which is then interfaced to other components of the drilling apparatus 10. The control features of the present invention may also be distributed among the components of the drilling apparatus 10. Thus, while certain features are described as residing in the control system 20, the invention is not so limited, and those features may be implemented elsewhere. The control system 20 and computer programs described herein are merely examples of computer equipment and programs that may be used to implement the present invention and may be replaced with or supplemented with other controllers and computer programs without departing from the scope of the present invention.

In some embodiments of the invention, the control system 20 may include or may be communicably coupled with a position sensor 52 attached to the end effector housing 22 and configured to provide the control system 20 with data regarding the end effector's distance from the workpiece 14 along a z-axis and/or its relevant position along a surface of the workpiece 14 along an x-axis and/or a y-axis. For example, the position sensor 52 may be a laser distance sensor configured to transmit information corresponding to the end effector's distance from the workpiece 14 along a z-axis.

In use, the drilling apparatus 10 may be utilized for performing a method for perforating or drilling holes into the workpiece 14. The method may include clamping the drill bit 18, having the narrow flute portion 46, as described above, into the drill bit attachment 24. Next, the method may include the steps of positioning the drilling apparatus 10 at a desired location relative to the workpiece 14 and actuating the rotation actuator 26, thereby rotating the drill bit 18 about its axis. Then, the method may include a step of actuating the drill bit 18 toward and into the workpiece 14 at the first speed until the widest portion has cleared the workpiece 14, such that space exists between boundaries of the hole 12 formed thereby and the flute portion 46 of the drill bit 18. The method may further include a step of actuating the drill bit 18 in a direction back through the hole 12 and away from the workpiece 14 at the second speed. The second speed may be greater than the first speed.

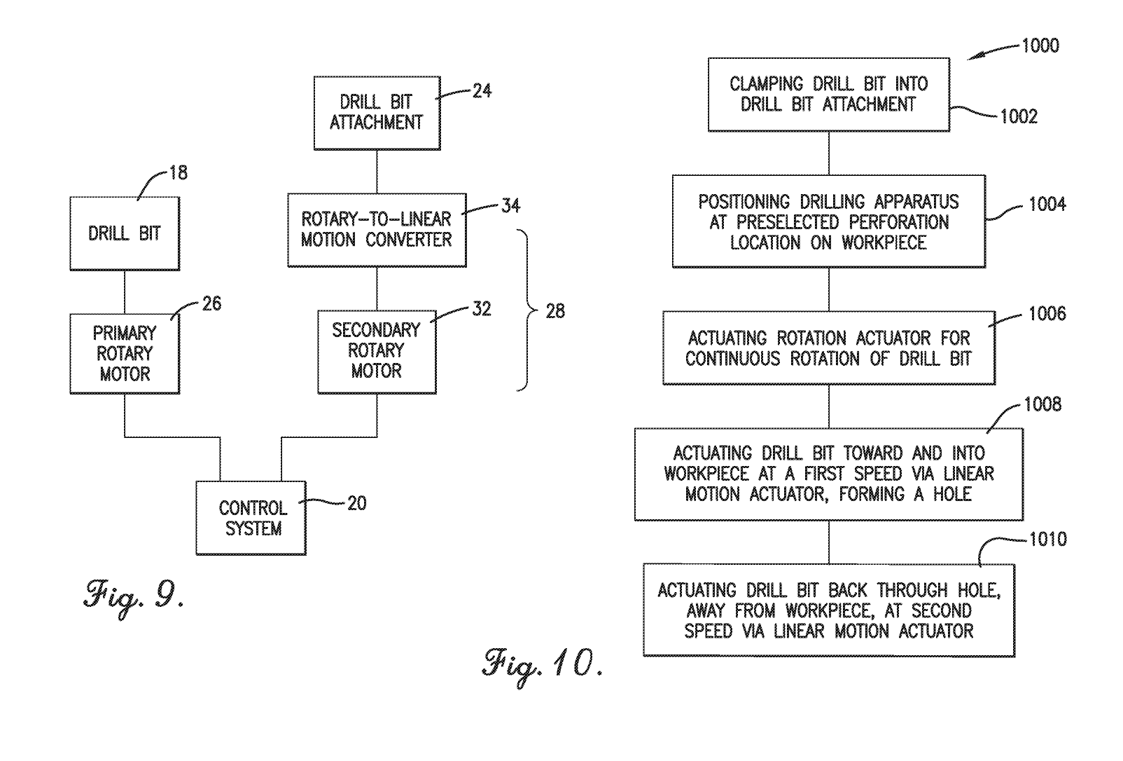

Method steps for perforating or drilling holes into the workpiece will now be described in more detail, in accordance with various embodiments of the present invention. The steps of the method 1000 may be performed in the order as shown in FIG. 10, or they may be performed in a different order. Furthermore, some steps may be performed concurrently as opposed to sequentially. In addition, some steps may not be performed.

As illustrated in FIG. 10, the method 1000 for perforating or drilling holes into the workpiece 14 may include clamping the drill bit 18 into the drill bit attachment 24, as depicted in block 1002. The drill bit 18 may include the tip 42, the widest portion 44, and the narrow flute portion 46, as described above. Next, the method 1000 may include the step of positioning the drilling apparatus 10 at a preselected perforation location on the workpiece 14, as depicted in block 1004. The positioning of the drilling apparatus 10 may be performed by one or more of the actuators 26,28 of the drilling apparatus 10 via instructions from the control system 20 and/or proximity or location data received by the position sensor 52 described above. Furthermore, the control system 20 may use CAD drawings or other such stored data to determine a relative position on the workpiece for drilling one of the holes. Note that other robotic joints and actuators known in the art, but not described in detail herein, may be used to move the drilling apparatus 10 into position without departing from the scope of the invention. Additionally or alternatively, at least some positioning of the drilling apparatus 10 may be performed manually by an operator without departing from the scope of the invention.

The method 1000 may then include a step of actuating the rotation actuator 26, as depicted in block 1006, thereby rotating the drill bit 18 about its axis. Actuation of the rotation actuator 26 may be triggered by merely turning on or connecting electrical power to the drilling apparatus 10 via an electrical plug, a battery, and/or a switch, button, or the like. Additionally or alternatively, actuation of the rotation actuator 26 may be accomplished via instructions from the control system 20 communicated via wired or wireless communication channels to the rotation actuator 26.

In addition, the method 1000 may include a step of actuating the drill bit 18 toward and into the workpiece 14 at the first speed, as depicted in block 1008, thereby plunging the drill bit 18 into the workpiece 14 until the widest portion 44 of the drill bit 18 has cleared the workpiece 14. Due to the design of the narrow flute portion 46 described above, when the widest portion 44 clears the workpiece 14, forming the hole 12 therethrough, space should exist between boundaries of the hole 12 and the flute portion 46 of the drill bit 18. Actuation of the drill bit 18 toward the workpiece 14 may be performed by instructions provided from the control system 20 to the linear motion actuator 28.

Finally, the method 1000 may include a step of actuating the drill bit 18 in a direction back through the hole 12 and away from the workpiece 14 at the second speed, as depicted in block 1010. The second speed may be greater than the first speed. Specifically, the control system 20 may send a control signal to the linear motion actuator 28, commanding the linear motion actuator 28 to increase the speed of the secondary rotary motor 32 to the second speed. For example, this method step may include receiving a sensor signal indicating a rotational location of the secondary rotary motor 32, such that the sensor signal indicates a position at which the drill bit 18 begins to retract in a direction away from the workpiece 14. Alternatively, this method step may include the control system 20 accessing rotational speed data stored therein or sensed thereby, or any other data sufficient to calculate when the secondary rotary motor 32 should increase to the second speed. In some embodiments of the invention, as described above, step 810 may be performed substantially automatically via cams or oblong-shaped gears driven by the secondary rotary motor 32.

The drilling apparatus 10 and methods described herein advantageously provide the benefits and conveniences of robotic drilling while producing hole quality typical of slow and expensive machine tools. Prior art drilling equipment tends to operate at either a constant force or a constant feed rate. By allowing a continuously variable feed rate profile, the drilling apparatus 10 enables a process that requires different rates at different parts of the drilling cycle. By utilizing the rotary-to-linear motion converter 34, the secondary rotary motor 32 actuating linear motion of the end effector 16 and/or drill bit 18 is kept running in a single direction, resulting in quicker acceleration and eliminating any lag time present when reversing motor directions in prior art systems during withdrawal of the drill bit from the hole 12 created.

Furthermore, the drilling apparatus 10 and methods described herein are designed to minimize the time during which exterior sides of the drill bit 18 are in contact with interior sides of the holes created thereby. Specifically, applicants have discovered that anytime there is contact between the sides of the holes and the sides of the drill bit 18, relative motion between the drill and the workpiece 14 may cause elongation of the hole 12. Applicants have further discovered that this elongation requires not only contact, but some amount of residence time. If side-to-side contact between the drill bit 18 and hole 12 takes place, a hole without significant elongation may still be produced, provided that the duration of the contact is minimized. Due to variations in the workpiece's thickness, positioning accuracy of the workpiece 14, drill bit installation depth, robot accuracy, and other factors, the drill bit 18 must be inserted into the workpiece 14 well beyond a point at which the hole 12 is fully formed. It is during this extra insertion that the reduced diameter of the drill bit 18 along the flute portion 46 provides clearance and prevents side-to-side contact. When the drill bit 18 is withdrawn from the hole 12, it will necessarily return the widest portion 44 of the drill bit 18 to the hole 12, and for a time, no clearance will exist during the withdrawal. However, the continuously variable linear motion or feed capabilities of the end effector 16 permit the extraction rate to be increased well beyond the rate used during insertion of the drill bit 18 and hole formation. This advantageously minimizes elongation during withdrawal.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A drilling apparatus comprising:
an end effector including an end effector housing and one or more actuators;
a drill bit attached to the end effector, wherein the drill bit includes a forward end, an aftward end opposite the forward end, a tip formed at the forward end, a widest portion aftward of the tip, and a narrow flute portion aftward of the widest portion, wherein the flute portion extends between the widest portion and the end effector, wherein the flute portion has a smaller diameter than the widest portion; and
a control system configured to send control signals to the actuators commanding rotation of the drill bit and commanding movement of the drill bit laterally outward and inward.

2. The drilling apparatus of claim 1, wherein the control system commands at least one of the actuators to move the drill bit laterally outward at a first speed and to move the drill bit laterally back inward at a second speed, wherein the second speed is faster than the first speed.

3. The drilling apparatus of claim 1, wherein the end effector includes a drill bit attachment configured for clamping the drill bit centrally therein.

4. The drilling apparatus of claim 3, wherein the actuators of the end effector include a rotation actuator configured to actuate rotation of the drill bit attachment.

5. The drilling apparatus of claim 3, wherein the actuators of the end effector include a lateral motion actuator configured to laterally move the end effector and drill bit outward and inward.

6. The drilling apparatus of claim 5, wherein the lateral motion actuator includes a rotary motor and a rotary-to-linear motion converter configured to convert rotary motion of the rotary motor into linear motion of the drill bit attachment and the drill bit.

7. The drilling apparatus of claim 1, wherein an included angle of the drill bit between the tip and the widest portion is between 50-degrees and 110-degrees.

8. The drilling apparatus of claim 1, wherein an included angle of the drill bit between the tip and the widest portion is between 80-degrees and 100-degrees.

9. The drilling apparatus of claim 1, wherein the narrow flute portion has a tapered configuration, beginning at the widest portion of the drill bit and extending in a direction toward the aftward end of the drill bit.

10. The drilling apparatus of claim 1, wherein the widest portion of the drill bit has a smaller length than the narrow flute portion.

11. The drilling apparatus of claim 1, further comprising a position sensor communicably coupled with the control system and configured for indicating proximity of the drill bit or end effector to a workpiece to be drilled.

12. A drilling apparatus configured for drilling holes into a composite workpiece, the drilling apparatus comprising:
an end effector including:
an end effector housing,
a drill bit attachment extending outward from the end effector housing,
a rotation actuator coupled with the drill bit attachment and configured for actuating rotation of the drill bit attachment, and
a linear motion actuator configured to actuate linear motion of the drill bit attachment toward and away from the workpiece;
a drill bit attached to the drill bit attachment, wherein the drill bit includes a forward end, an aftward end opposite the forward end, a tip formed at the forward end, a widest portion aftward of the tip, and a narrow flute portion aftward of the widest portion, wherein the flute portion extends between the widest portion and the end effector, wherein the flute portion has a smaller diameter than the widest portion, wherein the widest portion has a smaller length than the narrow flute portion; and
a control system configured to send control signals to the end effector commanding the end effector to rotate the drill bit and commanding the end effector to move laterally outward and inward, wherein the control system commands the end effector to move laterally outward toward the workpiece at a first speed and commands the end effector to move laterally back inward away from the workpiece at a second speed, wherein the second speed is faster than the first speed.

13. The drilling apparatus of claim 12, wherein the lateral motion actuator includes a rotary-to-linear motion converter mechanically configured to convert rotary motion into linear motion of the drill bit attachment.

14. The drilling apparatus of claim 12, wherein an included angle of the drill bit between the tip and the widest portion is between 80-degrees and 100-degrees.

15. The drilling apparatus of claim 12, further comprising a position sensor communicably coupled with the control system and configured for indicating proximity of the drill bit or end effector to a workpiece to be drilled.

16. A method of drilling holes into a composite workpiece with a drilling apparatus, the method comprising:
actuating rotation of a drill bit attachment with a drill bit attached therein;
actuating the drill bit attachment linearly toward the composite workpiece at a first speed, thereby forming a hole through the composite workpiece; and
actuating the drill bit attachment linearly away from the composite workpiece at a second speed, wherein the second speed is greater than the first speed to limit an amount of time that a relatively wider portion of the drill bit contacts the workpiece during withdrawal of the drill bit from the composite workpiece.

17. The method of claim 16, further comprising the step of clamping the drill bit into the drill bit attachment prior to actuating rotation of the drill bit attachment.

18. The method of claim 16, further comprising a step of a control system positioning the drilling apparatus at a preselected perforation location on the workpiece based on at least one of data stored in and data accessed by the control system.

19. The method of claim 16, wherein the steps of actuating the drill bit attachment linearly toward the composite workpiece and linearly away from the composite workpiece are performed via a lateral motion actuator, wherein the lateral motion actuator includes a rotary-to-linear motion converter mechanically configured to convert rotary motion into linear motion of the drill bit attachment.

20. The method of claim 19, wherein actuating the drill bit attachment linearly toward and away from the workpiece includes a rotary motor, coupled with the rotary-to-linear motion converter, rotating in a same single rotational direction for moving both toward and away from the composite workpiece.
